(19) United States
(12) Patent Application Publication
(10) Pub. No.: US 2025/0358152 A1
(43) Pub. Date: Nov. 20, 2025

(54) WIRELESS COMMUNICATION DEVICE FOR CHANNEL ESTIMATION BASED ON POWER DELAY PROFILE AND OPERATING METHOD OF WIRELESS COMMUNICATION DEVICE

(71) Applicant: SAMSUNG ELECTRONICS CO., LTD., Suwon-si (KR)

(72) Inventors: Hoil KIM, Suwon-si (KR); Jinho KIM, Suwon-si (KR)

(73) Assignee: SAMSUNG ELECTRONICS CO., LTD., Suwon-si (KR)

(21) Appl. No.: 19/012,512

(22) Filed: Jan. 7, 2025

(30) Foreign Application Priority Data
May 16, 2024 (KR) 10-2024-0064148
Jul. 15, 2024 (KR) 10-2024-0093335

(51) Int. Cl. H04L 25/02; H04L 5/00

(52) U.S. Cl. CPC H04L 25/0224; H04L 5/0051

(57) ABSTRACT

An operating method of a wireless communication device may include obtaining a first pilot signal and a second pilot signal, estimating an autocorrelation in a frequency domain of the first pilot signal based on a power delay profile of the second pilot signal, generating a channel estimation weight based on the autocorrelation, and estimating a channel of a data signal based on the channel estimation weight and the first pilot signal.

### CROSS-REFERENCE TO RELATED APPLICATION

This application is based on and claims priority under 35 U.S.C. § 119 to Korean Patent Application Nos. 10-2024-0064148 and 10-2024-0093335, respectively filed on May 16, 2024 and Jul. 15, 2024, in the Korean Intellectual Property Office, the disclosures of which are incorporated by reference herein in their entireties.

### BACKGROUND

One or more embodiments of the present disclosure relate to a wireless communication device and an operating method thereof, and particularly relate to a wireless communication device for performing channel estimation by using a power delay profile and an operating method of the wireless communication device.

In many communication systems including 5^{th} generation (5G) and 6^{th} generation (6G) systems, wireless communication devices such as a base station and a terminal may receive signals and may demodulate and decode the received signals to detect transmitted data. A wireless communication device may receive a reference signal and may generate a power delay profile from the reference signal. For example, a wireless communication device may receive a plurality of reference signals and may generate a power delay profile for each of the plurality of reference signals. There may be a need for a method of estimating a channel based on a power delay profile.

### SUMMARY

One or more embodiments of the present disclosure provides a wireless communication device for estimating a channel based on a power delay profile and an operating method of the wireless communication device.

According to an aspect of the present disclosure, an operating method of a wireless communication device may include: obtaining a first pilot signal comprising a physical downlink shared channel (PDSCH) demodulation reference signal (DMRS), and a second pilot signal comprising at least one of a tracking reference signal (TRS), a channel state information-reference signal (CSI-RS), and a synchronization signal block (SSB); estimating an autocorrelation in a frequency domain of the first pilot signal based on a power delay profile of the second pilot signal; generating a channel estimation weight based on the autocorrelation; and estimating a channel of a data signal based on the channel estimation weight and the first pilot signal.

According to another aspect of the present disclosure, a wireless communication device may include a radio frequency integrated circuit (RFIC), and a processor configured to receive a first pilot signal and a second pilot signal through the RFIC. The processor is further configured to measure a power delay profile of the second pilot signal, estimate an autocorrelation in a frequency domain of the first pilot signal based on the power delay profile of the second pilot signal, generate a channel estimation weight based on the autocorrelation, and estimate a channel of a data signal based on the channel estimation weight and the first pilot signal. The first pilot signal includes a physical downlink shared channel (PDSCH) demodulation reference signal (DMRS), and the second pilot signal includes at least one of a tracking reference signal (TRS), a channel state information-reference signal (CSI-RS), and a synchronization signal block (SSB).

According to another aspect of the present disclosure, an operating method of a wireless communication device includes receiving a first pilot signal including at least one of a physical downlink shared channel (PDSCH) demodulation reference signal (DMRS) and a user equipment-specific reference signal (UE-RS) and a second pilot signal including at least one of a cell-specific reference signal (CRS), a tracking reference signal (TRS), a channel state information-reference signal (CSI-RS), and a synchronization signal block (SSB), determining a reference signal of the second pilot signal for performing power delay profile measurement from among the CRS, the TRS, the CSI-RS, and the SSB, measuring a power delay profile of the reference signal of the second pilot signal, generating a channel estimation weight for the first pilot signal based on the power delay profile of the reference signal, and estimating a channel of a data signal based on the channel estimation weight and the first pilot signal.

### BRIEF DESCRIPTION OF DRAWINGS

Embodiments will be more clearly understood from the following detailed description taken in conjunction with the accompanying drawings in which:

FIG. 1 illustrates a wireless communication system, according to one or more embodiments;

FIG. 2 illustrates resource allocation for a first pilot signal and a second pilot signal, according to one or more embodiments;

FIG. 3 is a schematic diagram illustrating a power delay profile (PDP), according to one or more embodiments;

FIG. 4 is a block diagram illustrating a wireless communication device, according to one or more embodiments;

FIG. 5 illustrates a wireless communication device, according to one or more embodiments;

FIG. 6 illustrates an operating method of a wireless communication device, according to one or more embodiments;

FIG. 7A illustrates a method by which a wireless communication device estimates a channel by using a measured PDP of a tracking reference signal (TRS), according to one or more embodiments;

FIG. 7B illustrates an example of resource mapping for a TRS;

FIG. 8 illustrates an operating method of a wireless communication device of a new radio (NR) system, according to one or more embodiments;

FIGS. 9A and 9B are diagrams for describing an operation in which a wireless communication device selects a reference signal for measuring a PDP based on a priority level, according to one or more embodiments;

FIG. 10 illustrates an operation in which a wireless communication device determines whether a reference signal is configured in the order of a TRS, a channel state information-reference signal (CSI-RS), and a synchronization signal block (SSB), according to one or more embodiments;

FIG. 11 is a diagram illustrating an operation of the wireless communication device of FIG. 5, according to one or more embodiments;

FIG. 12 illustrates an operating method of a wireless communication device operating in a long-term evolution (LTE) system and an NR system, according to one or more embodiments;

FIG. 13 illustrates an operating method of a wireless communication device, according to one or more embodiments;

FIG. 14 is a block diagram illustrating an electronic device, according to one or more embodiments; and

FIG. 15 is a diagram illustrating examples of a device for wireless communication, according to one or more embodiments.

### DETAILED DESCRIPTION OF EMBODIMENTS

Hereinafter, embodiments will be described in detail with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

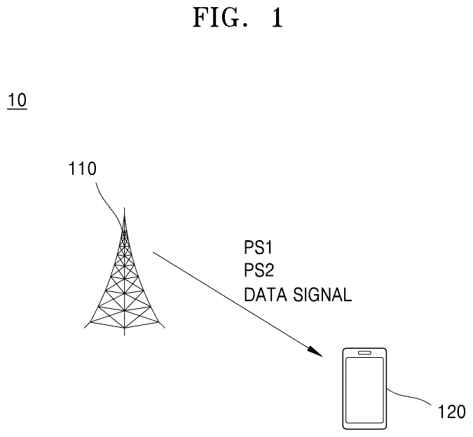

FIG. 1 illustrates a wireless communication system, according to one or more embodiments.

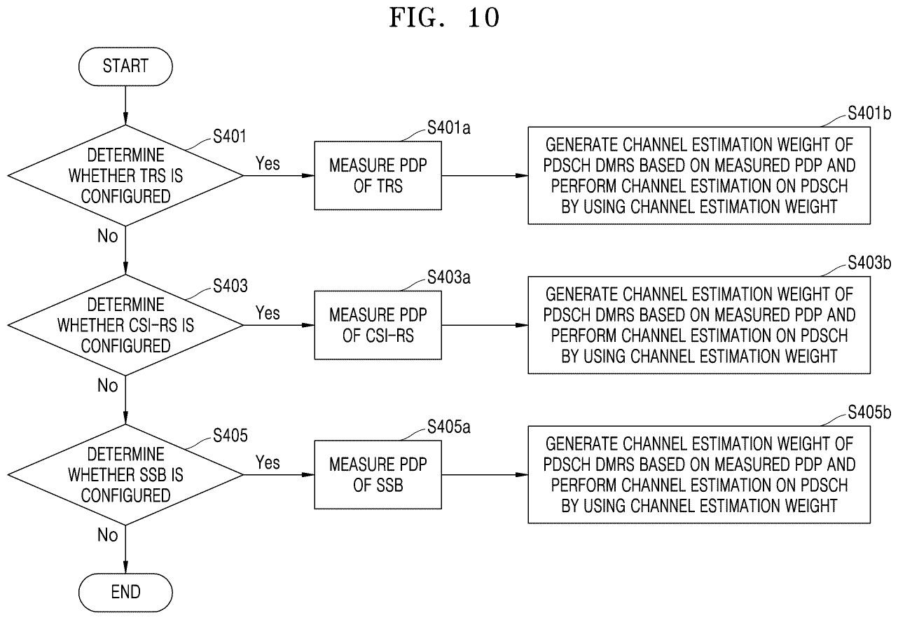

Referring to FIG. 1, a wireless communication system 10 may include a wireless communication device 120 and a base station 110. Although FIG. 10 illustrates that the wireless communication system 10 includes one base station 110 and one wireless communication device 120 for convenience of explanation, embodiments are not limited thereto, and the wireless communication system 10 may include a more number of base stations and a more number of wireless communication devices.

The base station 110 communicates with the wireless communication device 120 and allocates communication network resources to the wireless communication device 120, and may be any one of a NodeB (NB), an eNodB (eNB), a next generation radio access network (NG RAN), a wireless access unit, a base station controller, a node on a network, a gNodeB (gNB), and a transmission and reception point. The base station 110 may provide communication services in a geographical area known as a cell, through interactions with mobile devices within that area.

The wireless communication device 120 communicates with the base station 110 or another wireless communication device, and may be referred to as a node, a user equipment (UE), a next generation UE (NG UE), a mobile station (MS), a mobile equipment (ME), a device, or a terminal.

Also, the wireless communication device 120 may include at least one of a smartphone, a tablet PC, a mobile phone, a video phone, an e-book reader, a desktop PC, a laptop PC, a netbook computer, a personal digital assistant (PDA), a portable multimedia player (PMP), an MP3 player, a medical device, a camera, and a wearable device. Also, the wireless communication device 120 may include at least one of a television, a digital video disk (DVD) player, an audio system, a refrigerator, an air conditioner, a vacuum cleaner, an oven, a microwave oven, a washing machine, an air cleaner, a set-top box, a home automation control panel, a security control panel, a media box (e.g., Samsung HomeSync™, Apple TV™, or Google TV™), a game console (e.g., Xbox™ or PlayStation™), an electronic dictionary, an electronic key, a camcorder, and an electronic picture frame. Also, the wireless communication device 120 may include at least one of various medical devices (e.g., various portable medical measuring instruments (such as a blood glucose meter, a heart rate meter, a blood pressure meter, or a body temperature detector), a magnetic resonance angiography (MRA) machine, a magnetic resonance imaging (MRI) machine, a computed tomography (CT) scanning machine, and an ultrasonic machine), a navigation device, a global navigation satellite system (GNSS), an event data recorder (EDR), a flight data recorder (FDR), an automotive infotainment device, electronic equipment for ships (e.g., a navigation device for ships or a gyro compass), avonics, a security device, a head unit for vehicles, an industrial or household robot, a drone, an automated teller machine (ATM) of a financial institution, a point of sales (POS) of a store, and an Internet of things device (e.g., a light bulb, various sensors, a sprinkler device, a fire alarm, a temperature controller, a streetlight, a toaster, exercise equipment, a hot water tank, a heater, or a boiler). In addition, the wireless communication device 120 may include various types of multimedia systems capable of performing communication functions.

The base station 110 may be connected to the wireless communication device 120 through a wireless channel to provide various communication services. The base station 110 may serve all user traffic through a shared channel, and may collect state information of wireless communication device 120 such as a buffer state, an available transmission power state, and a channel state and perform scheduling.

The wireless communication system 10 may support beamforming technology using orthogonal frequency division multiplexing (OFDM) as wireless access technology. Also, the wireless communication system 10 may support an adaptive modulation and coding (AMC) method that determines a modulation scheme and a channel coding rate according to a channel state of the wireless communication device 120.

Also, the wireless communication system 10 may transmit and receive a signal by using a wide frequency band of 6 GHz or more. For example, the wireless communication system 10 may increase a data transmission rate by using a millimeter wave band such as a 28 GHz band or a 60 GHz band. In this case, because the millimeter wave band has a relatively large signal attenuation per distance, the wireless communication system 10 may support transmission and reception based on directional beams generated with multiple antennas to secure coverage. The wireless communication system 10 may be a system supporting multiple input and multiple output (MIMO), and thus, the base station 110 and the wireless communication device 120 may support beamforming technology. The beamforming technology may be divided into digital beamforming, analog beamforming, and hybrid beamforming.

The base station 110 may transmit a first pilot signal PS1 and a second pilot signal PS2 to the wireless communication device 120. The first pilot signal PS1 may be a reference signal for decoding a data signal, and may be specific to a user equipment (UE). For example, the first pilot signal PS1 may include a physical downlink shared channel (PDSCH) demodulation reference signal (DMRS). The second pilot signal PS2 may be a reference signal different from the first pilot signal PS1. The second pilot signal PS2 may be a cell-common signal that is common to all UEs within a given cell. Unlike UE-specific signals, which are tailored for individual UEs, cell-common signals are configured to be used by any UE in the coverage area of a particular cell. The second pilot signal PS2 may provide information for UEs to perform functions like synchronization, channel estimation, and cell identification. For example, the second pilot signal PS2 may include a tracking reference signal (TRS), a channel state information-reference signal (CSI-RS), and a synchronization signal block (SSB). The second pilot signal PS2 may include various other reference signals and is not limited to the above embodiments.

The wireless communication device 120 according to one or more embodiments measures a power delay profile (PDP) of the second pilot signal PS2. The wireless communication device 120 estimates an autocorrelation of a frequency domain of the first pilot signal PS1 by using the PDP. The wireless communication device 120 generates a channel estimation weight by using the autocorrelation. The wireless communication device 120 estimates a channel of a data signal based on the channel estimation weight and the first pilot signal PS1.

The wireless communication device 120 according to one or more embodiments may receive the first pilot signal PS1 including at least one of a PDSCH DMRS and a user equipment-specific reference signal (UE-RS) and the second pilot signal PS2 including at least one of a cell-specific reference signal (CRS), a TRS, a CSI-RS, and an SSB. The wireless communication device 120 may determine the second pilot signal PS2 for performing PDP measurement from among the CRS, the TRS, the CSI-RS, and the SSB. The wireless communication device 120 may measure a PDP of the second pilot signal PS2. The wireless communication device 120 may generate a channel estimation weight for the first pilot signal PS1 based on the PDP. The wireless communication device 120 may estimate a channel of a data signal based on the channel estimation weight and the first pilot signal.

The wireless communication device 120 according to the embodiments of the present application may enhance channel estimation accuracy by calculating a frequency domain autocorrelation directly from the measured PDP of the second pilot signal PS2, rather than obtaining time-related variables (e.g., maximum delay, mean delay, and root mean square (RMS) delay spread) from the PDP and then calculating the frequency domain autocorrelation based on the time-related variables.

The wireless communication device 120 according to embodiments of the present application may accurately estimate a channel of a data signal in a multi-path channel model having long delay spread.

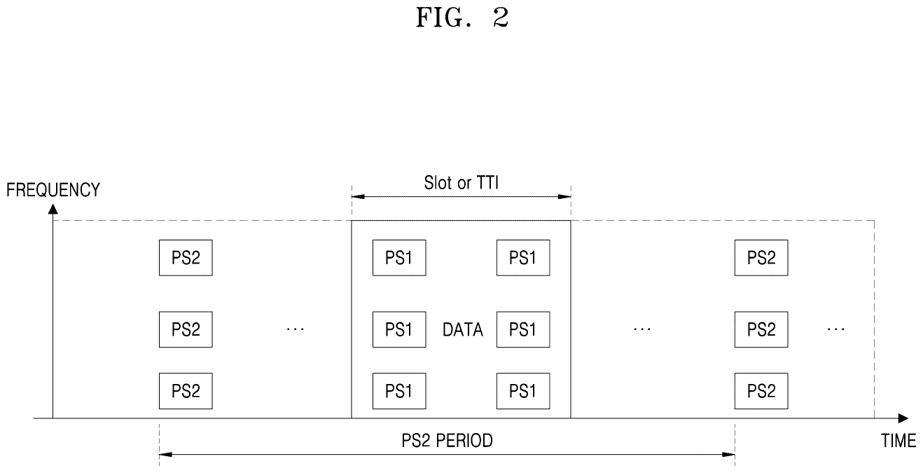

FIG. 2 illustrates resource allocation for a first pilot signal and a second pilot signal, according to one or more embodiments. In detail, FIG. 2 illustrates an example of transmission positions of a data signal, the first pilot signal PS1, the second pilot signal PS2 along a time axis and a frequency axis. FIG. 2 will be described with reference to FIG. 1.

Referring to FIG. 2, the first pilot signal PS1 may be transmitted in the same time slot or transmission time interval (TTI) as the data signal. That is, the first pilot signal PS1 may be transmitted alongside the data signal. Accordingly, the wireless communication device 120 may estimate a channel for the data signal during the time slot in which the first pilot signal PS1 is transmitted. For example, the wireless communication device 120 may perform minimum mean square error (MMSE) estimation on the channel of the data signal by using the first pilot signal PS1. In order for the wireless communication device 120 to perform MMSE estimation, an autocorrelation of the first pilot signal PS1 along the time axis and the frequency axis may be required. When the base station 110 transmits the first pilot signal PS1 that is narrowband precoded like the data signal to the wireless communication device 120, it may be difficult for the wireless communication device 120 to identify an autocorrelation of the first pilot signal PS1. Accordingly, the base station 110 may transmit the second pilot signal PS2 to the wireless communication device 120. Referring to FIG. 2, the second pilot signal PS2 may be transmitted at longer and more constant intervals than the first pilot signal PS1. The wireless communication device 120 may perform time and frequency synchronization by using the second pilot signal PS2 and may identify an autocorrelation of the first pilot signal PS1 by using the second pilot signal PS2.

The first pilot signal PS1 and the second pilot signal PS2 may have a quasi-colocation (QCL) relationship. For example, the first pilot signal PS1 and the second pilot signal PS2 may have a QCL-TypeA relationship. In detail, the first pilot signal PS1 and the second pilot signal PS2 may have similar channel conditions with respect Doppler shift, Doppler spread, mean delay, and delay spread.

The first pilot signal PS1 is a narrowband signal and may have a single precoding characteristic for each precoding resource block group (PRG). That is, the first pilot signal PS1 may have a common precoding characteristic for each PRG. A frequency band of the second pilot signal PS2 may be wider than a frequency band of the first pilot signal PS1. For example, the second pilot signal PS2 may be a wideband signal. According to one or more embodiments, the second pilot signal PS2 may be a wideband precoded reference signal. According to another embodiment, the second pilot signal may be a reference signal that is not precoded.

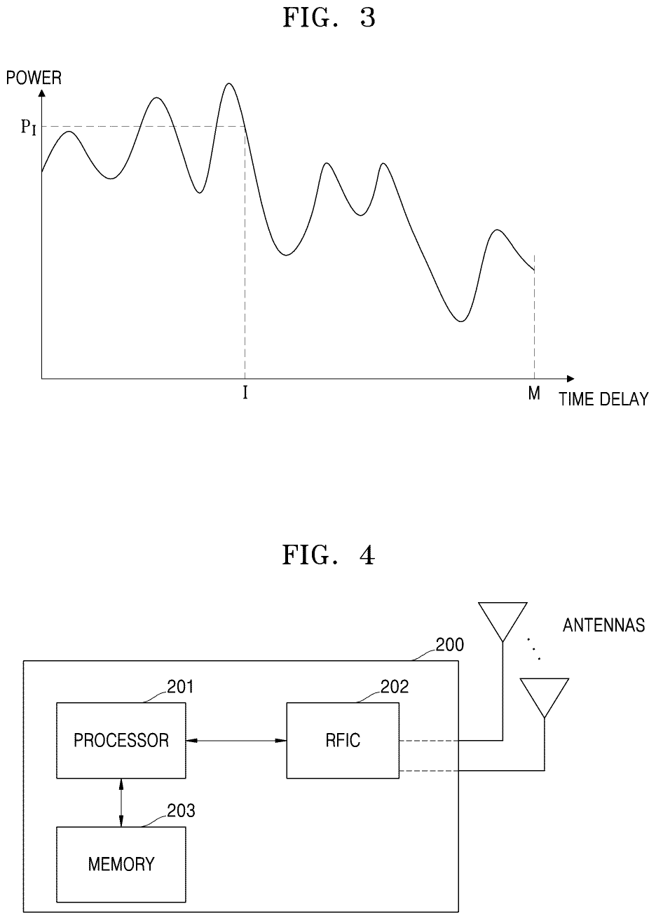

FIG. 3 is a schematic diagram illustrating a PDP, according to one or more embodiments.

A PDP is a function of time delay (t) for a multi-path channel and represents a signal intensity. Referring to FIG. 3, a horizontal axis represents a time delay [sec], and a vertical axis represents a signal intensity [dB]. The PDP may refer to a signal intensity of average power with respect to a time delay measured from a received signal experiencing various multi-paths.

Referring to FIG. 3, M denotes a duration of the time delay range over which the PDP is measured. Pₗ is a power value measured at a l^{th} channel tap.

FIG. 4 is a block diagram illustrating a wireless communication device, according to one or more embodiments.

Referring to FIG. 4, a wireless communication device 200 may include a processor 201, a radio-frequency integrated circuit (RFIC) 202, and a memory 203.

The processor 201 controls overall operations of the wireless communication device 200. For example, the processor 201 may transmit and receive a signal through the RFIC 202. Also, the processor 201 may write and read data to and from the memory 203. Also, the processor 201 may perform functions of a protocol stack required by the communication standard. Although each of the processor 201, the REIC 202, and the memory 203 is shown as one block for convenience of explanation, the wireless communication device 200 according to one or more embodiments may include a plurality of processors, a plurality of RFICs, and a plurality of memories. The processor 201 may control the wireless communication device 200 to perform operations according to various embodiments.

The RFIC 202 may perform functions for transmitting and receiving a signal. For example, the RFIC 202 may perform a conversion function between a baseband signal and a bit string according to a physical layer specification of a system. For example, during data transmission, the RFIC 202 may generate complex symbols by encoding and modulating a transmission bit string. Also, the RFIC 202 may up-convert a baseband signal into an RF band signal and then may transmit the RF band signal through an antenna, and may down-convert an RF band signal received through an antenna into a baseband signal. The RFIC 202 may include a transmission filter, a reception filter, an amplifier, a mixer, an oscillator, a digital-to-analog converter (DAC), and an analog-to-digital converter (ADC).

The memory 203 may store a basic program for operating the wireless communication device 120, an application program, and data such as setting information. The memory 203 may include a volatile memory, a nonvolatile memory, or a combination of a volatile memory and a nonvolatile memory. The memory 203 may provide stored data to the processor 201 according to a request of the processor 201.

The wireless communication device 200 according to one or more embodiments includes the RFIC 202 and the processor 201. The processor 201 receives a first pilot signal and a second pilot signal through the RFIC 202. The processor 201 may measure a PDP of the second pilot signal. The processor 201 may estimate an autocorrelation of a frequency domain of the first pilot signal by using the PDP. The processor 201 may generate a channel estimation weight by using the autocorrelation. The processor 201 may estimate a channel of a data signal based on the channel estimation weight and the first pilot signal. The first pilot signal includes a physical downlink shared channel (PDSCH) demodulation reference signal (DMRS), and the second pilot signal includes at least one of a tracking reference signal (TRS), a channel state information-reference signal (CSI-RS), and a synchronization signal block (SSB). The processor 201 may receive configuration information of the second pilot signal from a base station through the RFIC 202. The processor 201 may receive the configuration information through radio resource control (RRC) signaling. The processor 201 may measure a PDP of any one of the TRS, the CSI-RS, and the SSB based on the configuration information. The processor 201 may determine whether reference signals of a next time slot are configured by using the configuration information received from the base station. For example, the processor 201 may sequentially determine whether the TRS, the CSI-RS, and the SSB of the next time slot are configured by using the configuration information. The processor 201 may determine that the TRS of the next time slot is configured, and may measure a PDP of the TRS in the next time slot regardless of whether the CSI-RS and the SSB are configured. That is, when the TRS is configured, the processor 201 may measure the PDP of the TRS. The processor 201 may determine that the TRS is not configured in the next time slot and may determine whether the CSI-RS is configured. When the TRS is not configured and the CSI-RS is configured in the next time slot, the processor 201 may measure a PDP of the CSI-RS. The processor 201 may determine that the TRS and the CSI-RS are not configured in the next time slot, and may determine whether the SSB is configured. When the TRS and the CSI-RS are not configured and the SSB is configured in the next time slot, the processor 201 may measure a PDP of the SSB. For example, the processor 201 may measure a PDP of a physical broadcasting channel (PBCH) DMRS included in the SSB.

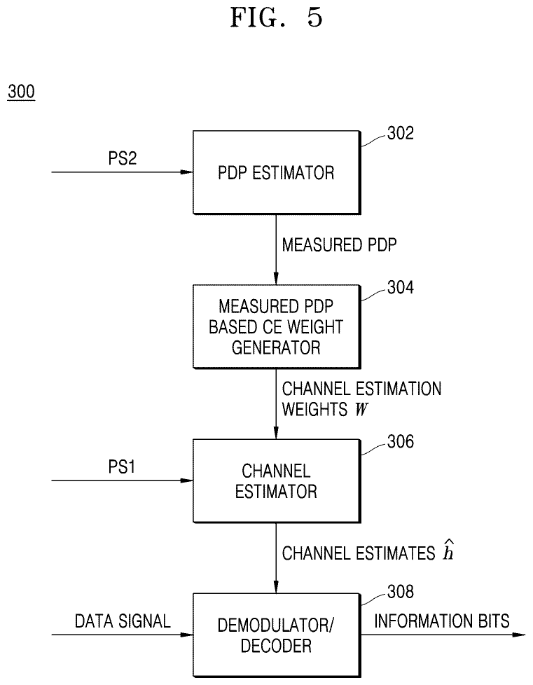

FIG. 5 illustrates a wireless communication device, according to one or more embodiments.

A wireless communication device 300 may be a part of the wireless communication device 200 of FIG. 4. Referring to FIG. 5, the wireless communication device 300 includes a PDP estimator 302, a measured PDP-based channel estimation (CE) weight generator 304, a channel estimator 306, and a demodulator/decoder 308. The PDP estimator 302, the measured PDP-based CE weight generator 304, the channel estimator 306, and the demodulator/decoder 308 may be included in one or more processors. The wireless communication device 300 may further include components for transmitting and receiving a data signal.

The PDP estimator 302 may measure a PDP of a second pilot signal PS2. In detail, the PDP estimator 302 may measure the PDP of the second pilot signal PS2 received through multiple paths having delay spread. The measured PDP may be referred to as an estimated PDP. The PDP estimator 302 may transmit the measured PDP to the measured PDP based CE weight generator 304. The PDP estimator 302 transmits the measured PDP itself to the measured PDP based CE weight generator 304, without extracting statistical channel characteristics including maximum delay, mean delay, and root mean square (RMS) delay spread from the measured PDP.

The measured PDP based CE weight generator 304 estimates an autocorrelation of a frequency domain of a first pilot signal PS1 by using the measured PDP. The measured PDP based CE weight generator 304 may obtain a frequency domain autocorrelation of the first pilot signal PS1 by using the measured PDP as shown in Equation 1.

$${r}_{f} ( {k}_{1} , {k}_{2} ) = {\sum }_{l = 0}^{M - 1} {P}_{l} {e}^{- j 2 π ( {k}_{1} - {k}_{2} ) l / N} \qquad [ Equation 1 ]$$

$$0 \leq {k}_{1} , {k}_{2} < {N}_{PRG} \qquad [ Equation 2 ]$$

In Equation 1, k₁ and k₂ are subcarrier indices within a precoding resource block group (PRG). Equation 2 shows a range of k₁ and k₂. r_{f}(k₁, k₂) denotes a frequency domain autocorrelation between a k₁^{th} subcarrier and a k₂^{th} subcarrier. N_{PRG} denotes the number of subcarriers within the PRG. The set {Pₗ} denotes power of a l^{th} tap within the estimated PDP. M denotes a time length of the estimated PDP. N denotes a size of fast Fourier transform (FFT) used in a communication system (e.g., a new radio (NR) reception system).

The measured PDP based CE weight generator 304 may generate a channel estimation weight for the first pilot signal PS1 by using the obtained frequency domain autocorrelation. The channel estimation weight may be referred to as a channel estimation coefficient. The measured PDP based CE weight generator 304 may generate the channel estimation weight based on Equation 3.

$$W = {{R}_{h p} ( {R}_{pp} + {σ}^{2} {I}_{{N}_{P}} )}^{- 1} \qquad [ Equation 3 ]$$

In Equation 3, W denotes a channel estimation weight matrix. The channel estimation weight matrix is a matrix with a size of N_{PRG}×Nₚ. N_{P} denotes the number of subcarriers of the first pilot signal PS1 within the PRG. N_{PRG} denotes the number of subcarriers within the PRG. Rₚₚ denotes an autocorrelation matrix with a size of N_{P}×N_{P}. I_{N}_{_{P}} denotes an identity matrix with a size of N_{P}×N_{P}. Rₕₚ is a cross-correlation matrix with a size of N_{PRG}×Nₚ. Rₕₚ is a cross-correlation matrix between a PRG channel h and a channel p of the first pilot signal PS1. σ² denotes power of noise in the first pilot signal PS1.

An element r_{f}(kₘ, kₙ) of the autocorrelation matrix Rₚₚ of Equation 3 may be expressed as shown in Equation 4. An element r_{f}(k_{d}, kₗ) of the cross-correlation matrix Rₕₚ of Equation 3 may be expressed as shown in Equation 5.

$${r}_{f} ( {k}_{m} , {k}_{n} ) {=}^{△} {\sum }_{l = 0}^{M I} {P}_{l} {e}^{- j 2 π ( {k}_{m} - {k}_{n} ) l / N} , \\ 1 \leq m , n \leq {N}_{p} , 0 \leq {k}_{m} , {k}_{n} < {N}_{PRG} \qquad [ Equation 4 ]$$

$${r}_{f} ( {k}_{d} , {k}_{l} ) {=}^{△} {\sum }_{l = 0}^{M - 1} {P}_{l} {e}^{- j 2 π ( {k}_{d} - {k}_{l} ) l / N} , \\ 1 \leq d \leq {N}_{PRG} , 1 \leq l \leq {N}_{p} , 0 \leq {k}_{d} {=}^{△} d - 1 < {N}_{PRG} \qquad [ Equation 5 ]$$

In Equations 4 and 5, kₘ, kₙ, and kₗ denote subcarrier indices of the first pilot signal PS1 within the PRG. kₘ, kₙ, and kₗ satisfy Equation 6.

$$0 \leq {k}_{m} , {k}_{n} , {k}_{l} < {N}_{PRG} \qquad [ Equation 6 ]$$

The measured PDP based CE weight generator 304 may transmit the channel estimation weight W to the channel estimator 306. The channel estimator 306 may estimate a channel based on the first pilot signal PS1 y and the channel estimation weight W. The channel estimator 306 may estimate a channel based on Equation 7.

$$\hat{h} = W \cdot {X}^{H} y \qquad [ Equation 7 ]$$

The measured PDP based CE weight generator 304 may transmit the channel estimation weight W to the channel estimator 306. ĥ denotes an estimated value for the channel h of subcarriers including both the data signal and the first pilot signal within the PRG. y denotes the first pilot signal PS1 and may be expressed as shown in Equation 8.

$$y = Xp + n \qquad [ Equation 8 ]$$

In Equation 8, the first pilot signal PS1 y is a column vector with a size of N_{P}, and X is a diagonal matrix having a scrambling sequence of the first pilot signal PS1.

The measured PDP based CE weight generator 304 may transmit the estimated channel matrix ĥ to the demodulator/decoder 308. The demodulator/decoder 308 may obtain information bits by demodulating and decoding the data signal by using the estimated channel matrix ĥ.

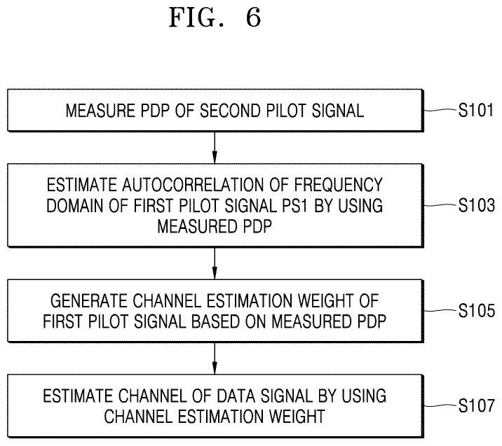

FIG. 6 illustrates an operating method of a wireless communication device, according to one or more embodiments. FIG. 6 will be described with reference to FIG. 4.

Referring to FIG. 6, in operation S101, the wireless communication device 200 may measure a PDP of a second pilot signal. The wireless communication device 200 may receive configuration information of the second pilot signal from a base station. The wireless communication device 200 may measure a PDP of any one of a TRS, a CSI-RS, and an SSB based on the configuration information. The wireless communication device 200 may receive the configuration information through radio resource control (RRC) signaling.

According to one or more embodiments, when the TRS is configured, the wireless communication device 200 may measure a PDP of the TRS. When the TRS is not configured and the CSI-RS is configured, a PDP of the CSI-RS may be measured. When the TRS is not configured, the CSI-RS is configured, the CSI-RS is for CSI-RS feedback, and the SSB is configured, a PDP of the SSB may be measured. When the TRS and the CSI-RS are not configured and the SSB is configured, the wireless communication device 200 may measure a PDP of the SSB. When the SSB is not configured, the wireless communication device 200 may repeat the above procedures again in a next time slot.

In operation S103, the wireless communication device 200 may measure an autocorrelation of a frequency domain of a first pilot signal PS1 by using the measured PDP.

In operation S105, the wireless communication device 200 may generate a channel estimation weight of the first pilot signal PS1 based on the measured PDP.

In operation S107, the wireless communication device 200 may estimate a channel of a data signal by using the channel estimation weight.

The first pilot signal is a narrowband signal and may have a common precoding characteristic for each precoding resource block group (PRG). A frequency band of the second pilot signal may be wider than a frequency band of the first pilot signal. The second pilot signal may be precoded.

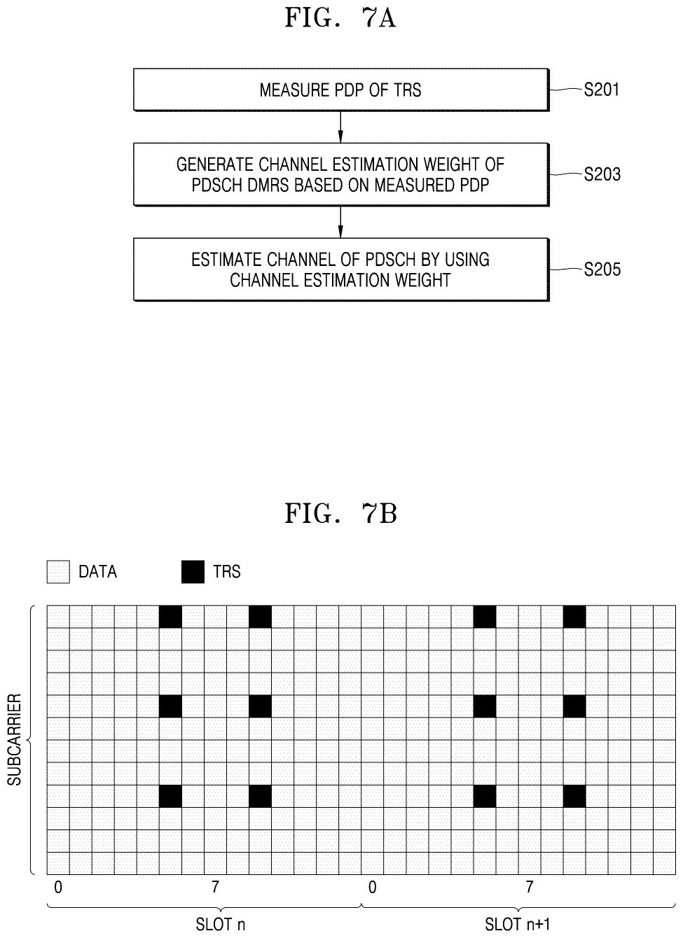

FIG. 7A illustrates a method by which a wireless communication device estimates a channel by using a measured PDP of a TRS, according to one or more embodiments. FIG. 7B illustrates an example of resource mapping for a TRS. FIG. 7A will be described with reference to FIG. 4.

Referring to FIG. 7A, in operation S201, the wireless communication device 200 may measure a PDP of a TRS.

In operation S203, the wireless communication device 200 may generate a channel estimation weight of a PDSCH DMRS based on the measured PDP.

In operation S205, the wireless communication device 205 may estimate a channel of a PDSCH by using the channel estimation weight.

Referring to FIG. 7B, a TRS may be transmitted in two consecutive time slots. The wireless communication device 200 may measure a PDP by using the TRS transmitted in the consecutive time slots.

The TRS may be wideband precoded. According to one or more embodiments, the wireless communication device 200 may measure a PDP of the TRS that is wideband precoded and may estimate a channel of a PDSCH based on the measured PDP.

The TRS may be transmitted only in a partial bandwidth. For example, the TRS may be transmitted using 52 resource blocks (RB). A base station may transmit the TRS to the wireless communication device 200 only in a partial bandwidth.

Also, the TRS may be a one-port signal transmitted based on one port. The wireless communication device 200 may measure a PDP of the TRS that is transmitted based on one port and may generate a channel estimation weight of a PDSCH DMRS by using the measured PDP.

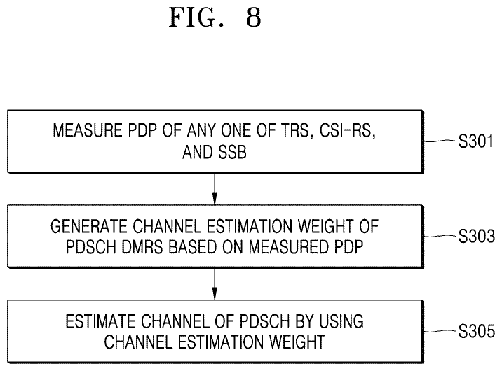

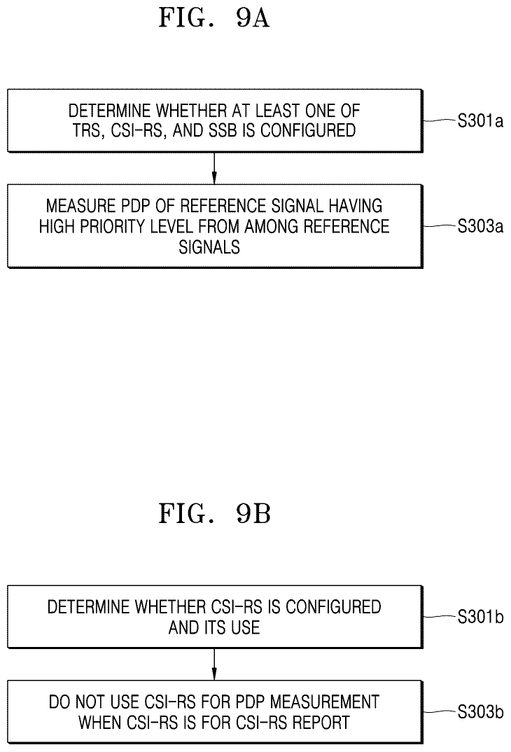

FIG. 8 illustrates an operating method of a wireless communication device of a new radio (NR) system, according to one or more embodiments. FIGS. 9A and 9B are diagrams for describing an operation in which a wireless communication device selects a reference signal for measuring a PDP based on a priority level, according to one or more embodiments. FIGS. 8, 9A, and 9B will be described with reference to FIG. 4.

Referring to FIG. 8, in operation S301, the wireless communication device 200 may measure a PDP of any one of a TRS, a CSI-RS, and an SSB as the PDP of a reference signal. According to one or more embodiments, referring to FIG. 9A, in operation S301a, the wireless communication device 200 may determine whether the TRS, the CSI-RS, and the SSB are configured. The terms “set” and “configure” used herein may be interchangeably used. In operation S303a, the wireless communication device 200 may a reference signal which has the highest priority among a plurality of reference signals, and measure a PDP of the selected reference signal. Information about the priority of the reference signals may be predetermined and stored in the wireless communication device 200, and/or may be received from a base station. For example, the wireless communication device 200 may determine a priority order of the TRS, the CSI-RS, and the SSB among the reference signals. For example, when the TRS is a reference signal with the highest priority, the wireless communication device 200 may first determine whether the TRS is configured, and when the TRS is configured, the wireless communication device 200 may measure a PDP of the TRS. When the TRS is not configured and the CSI-RS has the second highest priority among the reference signals, the wireless communication device 200 may determine whether the CSI-RS is configured. Referring to FIG. 9B, in operation S301b, the wireless communication device 200 may determine whether the CSI-RS is configured and its use. When the CSI-RS is configured, the wireless communication device 200 may measure a PDP of the CSI-RS. In operation S303b, when the CSI-RS is for CSI-RS report, the wireless communication device 200 may not use the CSI-RS for PDP measurement. That is, when the CSI-RS is transmitted to the wireless communication device 200 for feedback to a base station, the wireless communication device 200 may not use the CSI-RS for PDP measurement. In this case, the wireless communication device 200 may determine whether the SSB is configured, and when the SSB is configured, may measure a PDP of the SSB.

Referring back to FIG. 8, in operation S303, the wireless communication device 200 may generate a channel estimation weight of a PDSCH DMRS based on the measured PDP.

In operation S305, the wireless communication device 200 may estimate a channel of a PDSCH by using the channel estimation weight.

The wireless communication device 200 according to the above embodiment may operate not only in the NR communication system but also in other communication systems.

FIG. 10 illustrates an operation in which a wireless communication device determines whether a reference signal is configured in the order of a TRS, a CSI-RS, and an SSB, according to one or more embodiments. FIG. 10 will be described with reference to FIG. 4.

Referring to FIG. 10, in operation S401, the wireless communication device 200 may determine whether a TRS is configured. In operation S401a, when the TRS is configured, the wireless communication device 200 may measure a PDP of the TRS. In operation S401b, the wireless communication device 200 may generate a channel estimation weight of a PDSCH DMRS based on the measured PDP, and may perform channel estimation on a PDSCH by using the channel estimation weight.

According to one or more embodiments, the wireless communication device 200 may determine whether the TRS is configured in N subsequent time slots. N is a positive integer. When the TRS is configured in the N subsequent time slots, the wireless communication device 200 may measure a PDP of the TRS in the N subsequent time slots. The wireless communication device 200 may generate a channel estimation weight of a PDSCH DMRS based on the measured PDP, and may perform channel estimation on a PDSCH by using the channel estimation weight.

In operation S403, when the TRS is not configured, the wireless communication device 200 may determine whether a CSI-RS is configured. According to one or more embodiments, the wireless communication device 200 may determine whether the CSI-RS is configured in N subsequent time slots. In operation S403a, when the CSI-RS is configured, the wireless communication device 200 may measure a PDP of the CSI-RS. According to one or more embodiments, the wireless communication device 200 may measure the PDP of the CSI-RS in the N subsequent time slots. In operation S403b, the wireless communication device 200 may generate a channel estimation weight of a PDSCH DMRS based on the measured PDP, and may perform channel estimation on a PDSCH by using the channel estimation weight.

In operation S405, when the CSI-RS is not configured, the wireless communication device 200 may determine whether an SSB is configured. According to one or more embodiments, the wireless communication device 200 may determine whether the SSB is configured in N subsequent time slots. In operation S405a, when the SSB is configured, the wireless communication device 200 may measure a PDP of the SSB. According to one or more embodiments, the wireless communication device 200 may measure the PDP of the SSB in the N subsequent time slots. In operation S405b, the wireless communication device 200 may generate a channel estimation weight of a PDSCH DMRS based on the measured PDP, and may perform channel estimation on a PDSCH by using the channel estimation weight.

Although FIG. 10 illustrates operations S401, S403, and S405 in sequential order, the determinations of whether TRI, CSI-RS, and SSB are configured may be performed in parallel or in a different order than shown in FIG. 10.

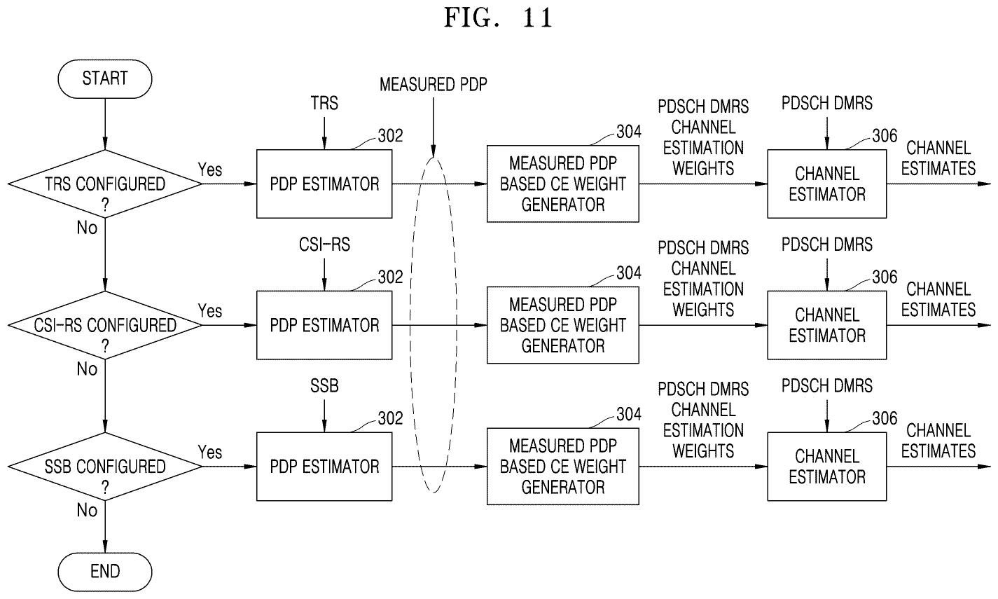

FIG. 11 is a diagram illustrating an operation of the wireless communication device of FIG. 5, according to one or more embodiments. FIG. 11 will be described with reference to FIG. 5.

Referring to FIG. 11, the wireless communication device 300 may determine whether a TRS is configured. When the TRS is configured, the PDP estimator 302 may measure a PDP of the TRS. The measured PDP based CE weight generator 304 may generate a channel estimation weight of a PDSCH DMRS based on the measured PDP, and the channel estimator 306 may perform channel estimation on a PDSCH by using the channel estimation weight.

According to one or more embodiments, the wireless communication device 300 may determine whether the TRS is configured in N subsequent time slots. N is a positive integer. When the TRS is configured in the N subsequent time slots, the PDP estimator 302 may measure a PDP of the TRS in the N subsequent time slots. The measured PDP based CE weight generator 304 may generate a channel estimation weight of a PDSCH DMRS based on the measured PDP, and the channel estimator 306 may perform channel estimation on a PDSCH by using the channel estimation weight.

When the TRS is not configured, the wireless communication device 300 may determine whether a CSI-RS is configured. According to one or more embodiments, the wireless communication device 300 may determine whether the CSI-RS is configured in N subsequent time slots. When the CSI-RS is configured, the wireless communication device 300 may measure a PDP of the CSI-RS. According to one or more embodiments, the PDP estimator 302 may measure the PDP of the CSI-RS in the N subsequent time slots. The measured PDP based CE weight generator 304 may generate a channel estimation weight of a PDSCH DMRS based on the measured PDP, and the channel estimator 306 may perform channel estimation on a PDSCH by using the channel estimation weight.

When the CSI-RS is not configured, the wireless communication device 300 may determine whether an SSB is configured. According to one or more embodiments, the wireless communication device 300 may determine whether the SSB is configured in N subsequent time slots. When the SSB is configured, the PDP estimator 302 may measure a PDP of the SSB. According to one or more embodiments, the PDP estimator 302 may measure a PDP of the SSB in the N subsequent time slots. The measured PDP based CE weight generator 304 may generate a channel estimation weight of a PDSCH DMRS based on the measured PDP, and the channel estimator 306 may perform channel estimation on a PDSCH by using the channel estimation weight.

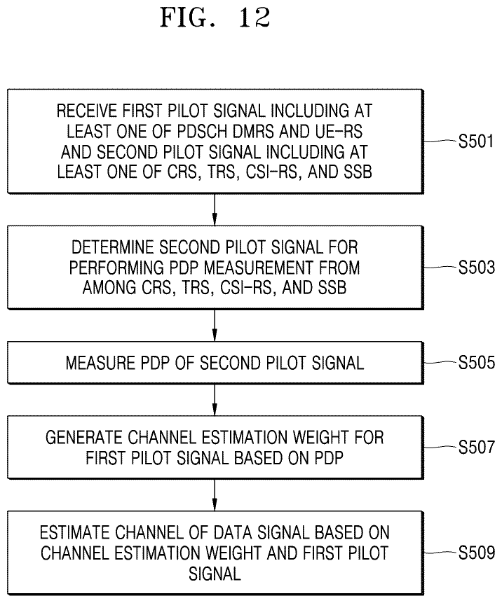

FIG. 12 illustrates an operating method of a wireless communication device in a long-term evolution (LTE) system and an NR system, according to one or more embodiments. FIG. 12 will be described with reference to FIG. 4.

Referring to FIG. 12, in operation S501, the wireless communication device 200 may receive a first pilot signal including at least one of a PDSCH DMRS and a UE-RS and a second pilot signal including at least one of a CRS, a TRS, a CSI-RS, and an SSB.

In operation S503, the wireless communication device 200 may determine the second pilot signal for performing PDP measurement from among the CRS, the TRS, the CSI-RS, and the SSB. For example, the wireless communication device 200 may receive configuration information of the second pilot signal from a base station. The wireless communication device 200 may determine the second pilot signal for performing PDP measurement based on the configuration information. The wireless communication device 200 may receive the configuration information from the base station through RRC signaling.

According to one or more embodiments, when the TRS is configured, the wireless communication device 200 may determine the TRS as the second pilot signal for measuring a PDP. When the TRS is not configured and the CSI-RS is configured, the wireless communication device 200 may determine the CSI-RS as the second pilot signal for measuring a PDP. When the TRS is not configured, the CSI-RS is configured, the CSI-RS is for CSI-RS feedback, and the SSB is configured, the wireless communication device 200 may determine the SSB as the second pilot signal for measuring a PDP.

According to one or more embodiments, when the CRS is configured, the wireless communication device 200 may determine the CRS as the second pilot signal for measuring a PDP. When the CRS is not configured and the CSI-RS is configured, the wireless communication device 200 may determine the CSI-RS as the second pilot signal for measuring a PDP.

In operation S505, the wireless communication device 200 may measure a PDP of the second pilot signal.

In operation S507, the wireless communication device 200 may generate a channel estimation weight for the first pilot signal based on the PDP. For example, the wireless communication device 200 may estimate an autocorrelation of a frequency domain of the first pilot signal by using the PDP. Also, the wireless communication device 200 may generate a channel estimation weight by using the autocorrelation.

In operation S509, the wireless communication device 200 may estimate a channel of a data signal based on the channel estimation weight and the first pilot signal.

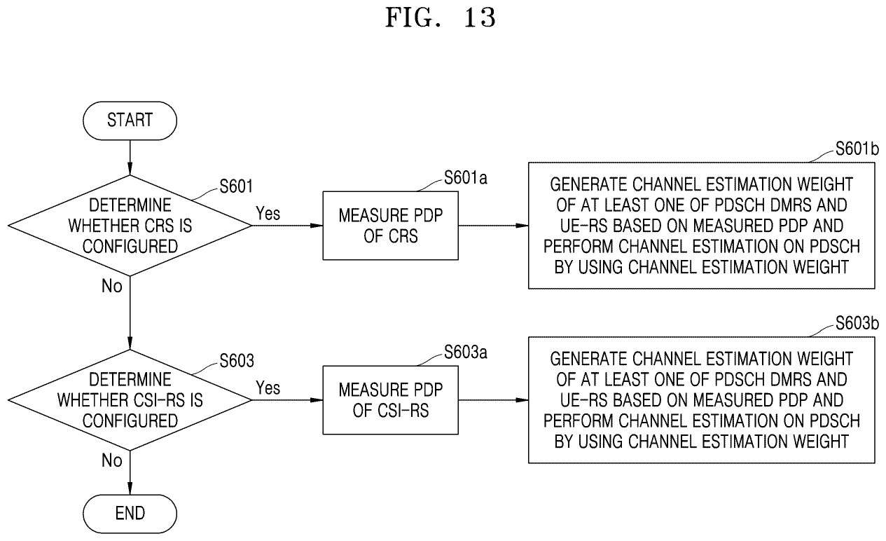

FIG. 13 illustrates an operating method of a wireless communication device, according to one or more embodiments. FIG. 13 will be described with reference to FIG. 4.

Referring to FIG. 13, in operation S601, the wireless communication device 200 may determine whether a CRS is configured. In operation S601a, when the CRS is configured, the wireless communication device 200 may measure a PDP of the CRS. In operation S601b, the wireless communication device 200 may generate a channel estimation weight of at least one of a PDSCH DMRS and a UE-RS based on the measured PDP, and may perform channel estimation on a PDSCH by using the channel estimation weight.

In operation S603, when the CRS is not configured, the wireless communication device 200 may determine whether a CSI-RS is configured. In operation S603a, when the CSI-RS is configured, the wireless communication device 200 may measure a PDP of the CSI-RS. In operation S603b, the wireless communication device 200 may generate a channel estimation weight of at least one of a PDSCH DMRS and a UE-RS based on the measured PDP, and may perform channel estimation on a PDSCH by using the channel estimation weight. When the CSI-RS is a signal for transmitting CSI-RS feedback to a base station, the wireless communication device 200 may not measure a PDP of the CSI-RS. The wireless communication device 200 may repeat the above procedures again in a next time slot.

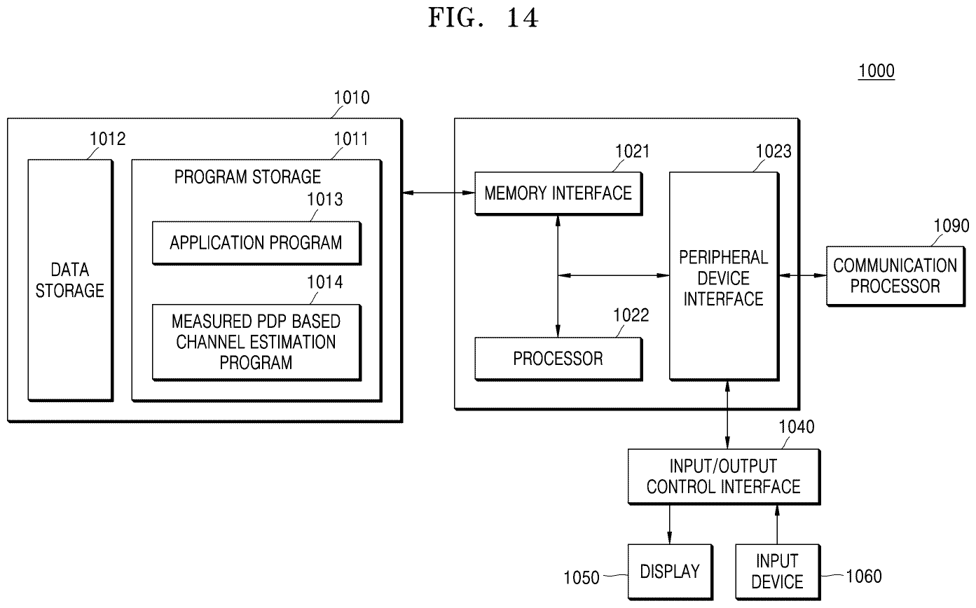

FIG. 14 is a block diagram illustrating an electronic device, according to one or more embodiments.

Referring to FIG. 14, an electronic device 1000 may include a memory 1010, a processor 1022, an input/output control interface 1040, a display 1050, an input device 1060, and a communication processor 1090. The electronic device 1000 may include a plurality of memories 1010. Each component is as follows.

The memory 1010 may include a program storage unit 1010 that stores a program for controlling an operation of the electronic device and a data storage 1012 that stores data generated during execution of the program. The data storage 1012 may store data required for operations of an application program 1013 and a measured PDP based channel estimation program 1014. The program storage 1011 may include the application program 1013 and the measured PDP based channel estimation program 1014. The program included in the program storage 1011 is a set of instructions, which may be expressed as an instruction set.

The application program 1013 includes an application program running on the electronic device. That is, the application program 1013 may include instructions of an application driven by a processor 1022. The measured PDP based channel estimation program 1014 may determine priority levels of reference signals for PDP measurement according to embodiments. The measured PDP based channel estimation program 1014 may perform channel estimation by using a measured PDP according to embodiments.

A peripheral device interface 1023 may control connection of the processor 1022 and the memory interface 1021 to an input/output peripheral device of a base station. The processor 1022 controls the base station to provide a corresponding service by using at least one software program. In this case, the processor 1022 may execute at least one program stored in the memory 1010 and may provide a service corresponding to the at least one program.

The input/output control interface 1040 may provide an interface between an input/output device, such as the display 1050 and the input device 1060, and the peripheral device interface 1023. The display 1050 displays state information, input characters, moving pictures, still pictures, etc. For example, the display 1050 may display application program information driven by the processor 1022.

The input device 1060 may provide input data generated by selection of the electronic device to the processor 1022 through the input/output control interface 1040. In this case, the input device 1060 may include a keypad including at least one hardware button and a touchpad for sensing touch information. For example, the input device 1060 may provide touch information, such as a touch, a touch movement, and a touch release, sensed through the touchpad, to the processor 1022 through the input/output control interface 1040. The electronic device 1000 may include the communication processor 1090 that performs a communication function for voice communication and data communication.

It will be understood by one of ordinary skill in the art that various changes in form and details may be made therein without departing from the spirit and scope of the inventive concept. When taking the foregoing description into account, if the modifications and variations of the inventive concept fall within the following claims and their equivalents, then it is construed that the inventive concept includes these modifications and variations.

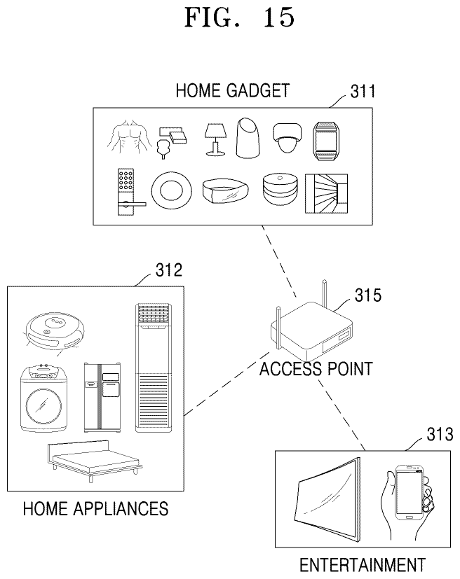

FIG. 15 is a diagram illustrating examples of a device for wireless communication, according to one or more embodiments.

Referring to FIG. 15, an Internet of things (IoT) network system including a home gadget 311, a home appliance 312, an entertainment device 313, and an access point 315 is illustrated.

Devices for wireless communication of FIG. 15 may determine priority levels of reference signals for PDP measurement, as described with reference to FIGS. 1 to 13. Also, in the devices for wireless communication of FIG. 15, the measured PDP based channel estimation program 1014 may perform channel estimation by using a measured PDP according to embodiments.

Embodiments have been described with reference to the drawings and the specification. While embodiments have been described by using specific terms, the terms have merely been used to explain the inventive concept and should not be construed as limiting the scope of the inventive concept defined by the claims. Hence, it will be understood by one of ordinary skill in the art that various modifications and other equivalent embodiments may be made therefrom. Accordingly, the technical scope of the inventive concept should be defined by the following claims.

While embodiments have been described by using specific terms, the terms have merely been used to explain the inventive concept and should not be construed as limiting the scope of the inventive concept defined by the claims. Hence, it will be understood by one of ordinary skill in the art that various modifications and other equivalent embodiments may be made therefrom. Accordingly, the technical scope of the inventive concept should be defined by the following claims.

While the inventive concept has been particularly shown and described with reference to embodiments thereof, it will be understood that various changes in form and details may be made therein without departing from the spirit and scope of the following claims.

1. An operating method of a wireless communication device, the operating method comprising:
obtaining a first pilot signal comprising a physical downlink shared channel (PDSCH) demodulation reference signal (DMRS), and a second pilot signal comprising at least one of a tracking reference signal (TRS), a channel state information-reference signal (CSI-RS), and a synchronization signal block (SSB);
estimating an autocorrelation in a frequency domain of the first pilot signal based on a power delay profile of the second pilot signal;
generating a channel estimation weight based on the autocorrelation; and
estimating a channel of a data signal based on the channel estimation weight and the first pilot signal.

2. The operating method of claim 1, further comprising receiving configuration information of the second pilot signal from a base station,
measuring, as the power delay profile of the second pilot signal, a power delay profile of at least one of the TRS, the CSI-RS, and the SSB based on the configuration information.

3. The operating method of claim 2, wherein the measuring of the power delay profile comprises, when the TRS is configured, measuring the power delay profile of the TRS.

4. The operating method of claim 2, wherein the measuring of the power delay profile comprises, when the TRS is not configured and the CSI-RS is configured, measuring the power delay profile of the CSI-RS.

5. The operating method of claim 2, wherein the measuring of the power delay profile comprises, when the TRS is not configured, the CSI-RS is configured for CSI-RS feedback, and the SSB is configured, measuring the power delay profile of the SSB.

6. The operating method of claim 2, wherein the measuring of the power delay profile comprises, when the TRS and the CSI-RS are not configured and the SSB is configured, measuring the power delay profile of the SSB.

7. The operating method of claim 2, wherein the configuration information is received through radio resource control (RRC) signaling.

8. The operating method of claim 1, wherein the first pilot signal has a single precoding characteristic for each precoding resource block group (PRG).

9. The operating method of claim 1, wherein a frequency band of the second pilot signal is wider than a frequency band of the first pilot signal.

10. The operating method of claim 1, wherein the second pilot signal is precoded.

11. A wireless communication device comprising:
a radio frequency integrated circuit (RFIC); and
a processor configured to:
receive a first pilot signal and a second pilot signal through the RFIC;
measure a power delay profile of the second pilot signal;
estimate an autocorrelation in a frequency domain of the first pilot signal based on the power delay profile of the second pilot signal;
generate a channel estimation weight based on the autocorrelation; and
estimate a channel of a data signal based on the channel estimation weight and the first pilot signal,
wherein the first pilot signal comprises a physical downlink shared channel (PDSCH) demodulation reference signal (DMRS), and
the second pilot signal comprises at least one of a tracking reference signal (TRS), a channel state information-reference signal (CSI-RS), and a synchronization signal block (SSB).

12. The wireless communication device of claim 11, wherein the processor is further configured to
receive configuration information of the second pilot signal from a base station through the RFIC, and
measure, the power delay profile of the second pilot signal, a power delay profile of any one of the TRS, the CSI-RS, and the SSB based on the configuration information.

13. The wireless communication device of claim 12, wherein the processor is further configured to, when the TRS is configured, measure the power delay profile of the TRS.

14. The wireless communication device of claim 12, wherein the processor is further configured to, when the TRS is not configured and the CSI-RS is configured, measure the power delay profile of the CSI-RS.

15-20. (canceled)

21. An operating method of a wireless communication device, the operating method comprising:
receiving a first pilot signal comprising at least one of a physical downlink shared channel (PDSCH) demodulation reference signal (DMRS) and a user equipment-specific reference signal (UE-RS) and a second pilot signal comprising at least one of a cell-specific reference signal (CRS), a tracking reference signal (TRS), a channel state information-reference signal (CSI-RS), and a synchronization signal block (SSB);
determining a reference signal of the second pilot signal for performing power delay profile measurement, from among the CRS, the TRS, the CSI-RS, and the SSB;
measuring a power delay profile of the reference signal of the second pilot signal;
generating a channel estimation weight for the first pilot signal based on the power delay profile of the reference signal; and
estimating a channel of a data signal based on the channel estimation weight and the first pilot signal.

22. The operating method of claim 21, wherein the generating of the channel estimation weight for the first pilot signal based on the power delay profile comprises:
estimating an autocorrelation in a frequency domain of the first pilot signal based on the power delay profile; and
generating the channel estimation weight based on the autocorrelation.

23. The operating method of claim 21, further comprising receiving configuration information of the second pilot signal from a base station,
wherein the determining of the reference signal of the second pilot signal comprises determining the reference signal of the second pilot signal based on the configuration information.

24. The operating method of claim 23, wherein the configuration information is received through radio resource control (RRC) signaling.

25. The operating method of claim 23, wherein the determining of the reference signal of the second pilot signal comprises:
when the TRS is configured, determining the TRS as the reference signal of the second pilot signal for measuring the power delay profile;
when the TRS is not configured and the CSI-RS is configured, determining the CSI-RS as the reference signal of the second pilot signal for measuring the power delay profile; and
when the TRS is not configured, the CSI-RS is configured, the CIS-RS is for CSI-RS feedback, and the SSB is configured, determining the SSB as the reference signal of the second pilot signal for measuring the power delay profile.

26. The operating method of claim 23, wherein the determining of the reference signal of the second pilot signal comprises:
when the CRS is configured, determining the CRS as the reference signal of the second pilot signal for measuring the power delay profile; and
when the CRS is not configured and the CSI-RS is configured, determining the CSI-RS as the reference signal of the second pilot signal for measuring the power delay profile.
